(19) United States
(12) Patent Application Publication
(10) Pub. No.: US 2026/0307948 A1
(43) Pub. Date: Oct. 8, 2026

(54) CLAMPING MECHANISM AND LIMITING MECHANISM FOR LIFTING DEVICE

(71) Applicants: INTRADIN (HUZHOU) INTELLIGENT TECHNOLOGY CO., LTD., Huzhou (CN); GREAT CIRCLE MACHINERY CORP, ONTARIO, CA (US)

(72) Inventors: Junliang WANG, Huzhou (CN); Xiaobo XU, Huzhou (CN)

(21) Appl. No.: 19/680,462

(22) Filed: May 18, 2026

(30) Foreign Application Priority Data
Mar. 27, 2026 (CN) 202610391485.4

(51) Int. Cl. B66C 1/62; B66C 1/22; B66C 1/44

(52) U.S. Cl. CPC B66C 1/625; B66C 1/223; B66C 1/44

(57) ABSTRACT

A clamping mechanism for a lifting includes a mounting frame, at least two clamping plates, a vertical column and a linkage structure. Two ends of the mounting frame are each provided with a mounting shaft. The clamping plates are each hinged to the mounting frame via the mounting shaft. The vertical column is vertically arranged on the mounting frame, and is located between the clamping plates. The linkage structure is arranged on the vertical column, and is configured to control the clamping plates in a clamping or releasing state. A limiting mechanism is also provided for the lifting device, including a vertical column, a sliding plate and an elastic component, where the vertical column is provided with a first guide hole and a second limit pin; and the sliding plate is provided with a second guide hole and a first limit pin.

### CROSS-REFERENCE TO RELATED APPLICATIONS

This application claims the benefit of priority from Chinese Patent Application No. 202610391485.4, filed on March 27, 2026. The content of the aforementioned application, including any intervening amendments thereto, is incorporated herein by reference in its entirety.

### TECHNICAL FIELD

This application relates to lifting devices, and more particularly to a clamping mechanism and a limiting mechanism for a lifting device.

### BACKGROUND

In the fields of warehousing and logistics, chemical production and food processing, the handling, stacking, and lifting of cylindrical containers (e.g., material barrels, oil barrels and reaction tanks) are important parts of daily operations. Since such cylindrical containers generally have large size, heavy weight, and curved outer surfaces, how to enable stable and reliable clamping of the containers during the lifting operation has been a great challenge in the design stage.

At present, common clamping modes adopted in cylindrical-container lifting devices mostly rely on rigid hoops, double-sided hydraulically-driven clamping arms, or manual locking devices. For example, some devices employ two arc-shaped clamping plates, which are driven by a hydraulic cylinder or a screw mechanism to rotate around a fixed shaft, so as to clamp the barrel from both sides. However, the clamping mechanisms of the existing lifting devices are relatively complex in structure and require a large installation space, making it difficult to be compactly integrated into the lifting device. Therefore, this application provides a clamping mechanism for a lifting device to solve the abovementioned problems.

### S UMMARY

In a first aspect, the present disclosure provides a clamping mechanism for a lifting device.

A clamping mechanism, comprising:

a mounting frame;

at least two clamping plates;

a vertical column;

a linkage structure;

wherein the at least two clamping plates are hinged to two sides of the mounting frame, respectively;

the vertical column is arranged on the mounting frame; and

the linkage structure is arranged on the vertical column, and is configured to control the at least two clamping plates to be in a clamping state or a releasing state.

In some embodiments, the linkage structure comprises a first connection rod, two support rods, a second connection rod, a third connection rod and a first mounting shaft; the first connection rod is vertically arranged inside the vertical column; first ends of the two support rods are hinged to the at least two clamping plates, respectively, and second ends of the two support rods are hinged to a first end of the first connection rod; a first end of the second connection rod is hinged to a second end of the first connection rod; a second end of the second connection rod is hinged to an end of the third connection rod; and the third connection rod is hinged to the vertical column via the first mounting shaft.

In some embodiments, the linkage structure further comprises a first hinge shaft and a second hinge shaft; the second end of the first connection rod is hinged to the first end of the second connection rod via the first hinge shaft; and the second end of the second connection rod is hinged to the end of the third connection rod via the second hinge shaft.

In some embodiments, in response to a case that the first hinge shaft, the first mounting shaft and the second hinge shaft reach a collinear position or move past the collinear position, the first connection rod is configured to be locked.

In some embodiments, a retaining plate is movably sleeved outside the first connection rod; the retaining plate is fixedly connected to an inner wall of the vertical column; a first elastic component is provided between the first connection rod and the retaining plate; and the first elastic component is configured to drive the first connection rod to reset.

In some embodiments, the third connection rod is provided with a safety mechanism; the safety mechanism comprises a trigger, a limit part and a second mounting shaft; the trigger is rotatably arranged on the third connection rod via the second mounting shaft; and the limit part is arranged at an outer wall of a side of the vertical column close to a side of the trigger.

In some embodiments, the safety mechanism further comprises a torsion spring; the torsion spring is sleeved over the second mounting shaft; a first end of the torsion spring is configured to abut against the trigger; and a second end of the torsion spring is configured to abut against the third connection rod.

In some embodiments, the clamping mechanism further comprises a sliding plate slidably arranged on an outer wall of the vertical column; a side of the sliding plate close to the at least two clamping plates is provided with a hook; and the hook is configured to limit an upper end of an object clamped by the at least two clamping plates.

In some embodiments, a side of the vertical column close to the sliding plate is provided with a first guide hole; the first guide hole is internally provided with a first limit pin; a first end of the first limit pin is fixedly connected to the sliding plate; a second of the first limit pin is configured to extend into the vertical column; an end of the sliding plate away from the first guide hole is provided with a second guide hole; and the second guide hole is internally provided with the second limit pin.

In some embodiments, a second elastic component is provided between the first limit pin and the retaining plate, and is configured to maintain the hook at a position for limiting the object clamped by at least two clamping plates.

In a second aspect, the present disclosure provides a limiting mechanism for a lifting device.

A limiting mechanism for a lifting device, comprising:

a vertical column; and

a sliding plate;

wherein the sliding plate is slidably arranged on an outer wall of the vertical column; a side of the sliding plate away from the outer wall of the vertical column is provided with a hook; and the hook is configured to limit an upper end of a clamped object.

In some embodiments, a side of the vertical column close to the sliding plate is provided with a first guide hole; the sliding plate is provided with a first limit pin extending into the first guide hole; an end of the sliding plate away from the first guide hole is provided with a second guide hole; and the vertical column is internally provided with a second limit pin extending into the second guide hole.

In some embodiments, the limiting mechanism further comprises an elastic component; a first end of the elastic component is connected to the first limit pin; a second end of the elastic component is connected to the vertical column; and the elastic component is configured to maintain the hook at a position for limiting the clamped object.

The present disclosure has the following beneficial effects.

The clamping mechanism for the lifting device in this application adopts a symmetrical double-hinged structure integrated with a linkage actuation system, achieving efficient and stable clamping of barrel-shaped objects. It features a simple structure and convenient operation, requires no large installation space, and is easy to integrate into compact lifting devices.

### BRIEF DESCRIPTION OF THE DRAWINGS

In order to illustrate the technical solutions in the prior art or in the embodiments of the present disclosure more clearly, the accompanying drawings needed in the description of the prior art or the embodiments of the present disclosure will be briefly described below. Obviously, presented in the accompanying drawings are merely some embodiments, instead of all embodiments, of the disclosure, and other drawings can also be obtained by those skilled in the art based on these accompanying drawings without paying creative effort.

FIG. 1 is a front view of a clamping mechanism for a lifting device according to an embodiment of the present disclosure;

FIG. 2 is a rear view of the clamping mechanism according to an embodiment of the present disclosure;

FIG. 3 structurally shows a linkage structure of the clamping mechanism according to an embodiment of the present disclosure;

FIG. 4 is sectional view of the clamping mechanism according to an embodiment of the present disclosure (from a front view);

FIG. 5 is an enlarged view of portion A in FIG. 4;

FIG. 6 is an enlarged view of portion B in FIG. 4;

FIG. 7 structurally shows a side section of the clamping mechanism according to an embodiment of the present disclosure; and

FIG. 8 shows an internal structure of a vertical column of the clamping mechanism.

In the figures: 1-mounting frame; 11-first mounting shaft; 12-connecting plate; 13-notch; 14-housing; 15-cover plate; 2-clamping plate; 21-first end; 22-second end; 3-vertical column; 31-mounting hole; 32-avoidance cavity; 33-first guide hole; 34-retaining plate; 35-first side; 4-linkage structure; 41-first connection rod; 411-boss; 42-support rod; 421-first hinge shaft; 422-second hinge shaft; 43-second connection rod; 431-engagement notch; 432-third hinge shaft; 433-fourth hinge shaft; 44-third connection rod; 45-second mounting shaft; 46-actuation lever; 47-first elastic component; 5-safety mechanism; 51-trigger; 52-limit part; 53-third mounting shaft; 54-torsion spring; 6-sliding plate; 61-second guide hole; 62-first limit pin; 63-second limit pin; 64-hook; 65-pull handle; and 7-second elastic component.

The objects, features and advantages of the present disclosure will be illustrated with reference to the accompanying figures and embodiments.

### DETAILED DESCRIPTION OF EMBODIMENTS

The technical solutions of the embodiments in the present disclosure will be further described below with reference to the accompanying drawings in the embodiments. Obviously, described below are merely some embodiments of the present disclosure, not all embodiments. Based on the embodiments in the present disclosure, all other embodiments obtained by those of ordinary skill in the art without paying creative labor shall fall within the scope of the present disclosure.

It should be noted that all the directional indications (such as up and down, left and right, front and back, etc.) used herein are only used to explain the relative positional relationship or motion among the components under a specific posture (as shown in the attached figure). If the specific posture changes, the corresponding directional indication will be adjusted accordingly.

Furthermore, the expressions involving "first", "second", etc. in the present disclosure are only for descriptive purposes and should not be understood as indicating or implying the relative importance or the quantity of the technical features involved. Therefore, features defined by "first" or "second" can explicitly or implicitly indicate the inclusion of at least one of such features.

In addition, with respect to the term "and / or", taking "A and / or B" as an example, it includes technical solution A, technical solution B, and a combination thereof. The technical solutions in individual embodiments can be combined with each other as long as the combined solution can be realized by one of ordinary skill in the art. If the combination of technical solutions is contradictory or unachievable, it should be considered infeasible and not fall within the scope of the present disclosure.

This disclosure is mainly used for clamping bucket-shaped objects, such as a smooth round barrel, a material barrel, an oil barrel, etc., and can also be used to clamp objects of other shapes.

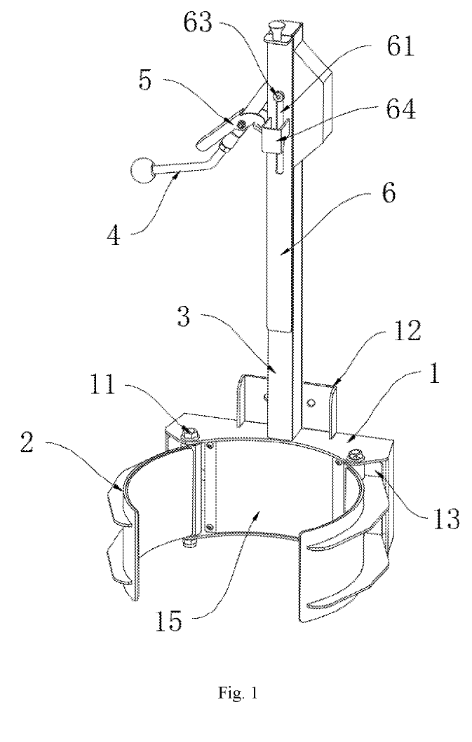

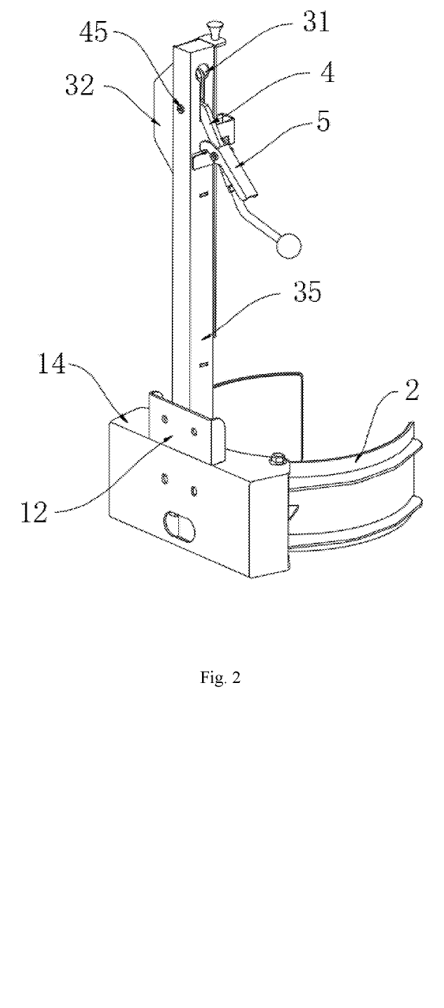

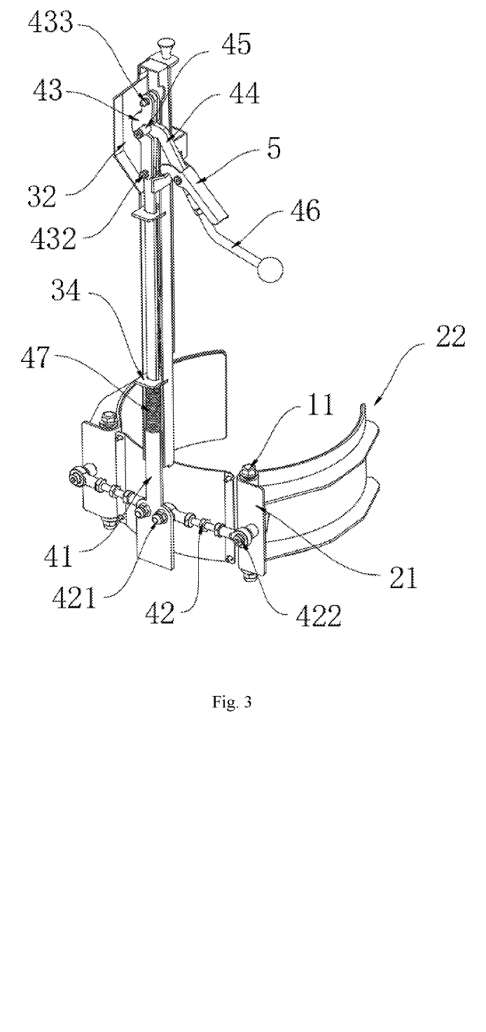

Referring to FIGS. 1-3, the present disclosure provides a clamping mechanism for a lifting device, including a mounting frame 1, at least two clamping plates 2, a vertical column 3, a linkage structure 4. The at least two clamping plates 2 are hinged to two sides of the mounting frame 1, respectively. The vertical column 3 is arranged on the mounting frame 1. The linkage structure 4 is arranged on the vertical column 3, and is configured to control the at least two clamping plates 2 to be in a clamping state or a releasing state.

In some embodiments, the mounting frame 1 is configured to be box-shaped. Two ends of the mounting frame 1 are each provided with a first mounting shaft 11, and a notch 13 is arranged at a position corresponding to the first mounting shaft 11, where the notch 13 is configured to allow an end of each of the at least two clamping plates 2 to extend into the mounting frame 1 therefrom. Two first mounting shafts 11 are symmetrically arranged at two ends of the mounting frame 1, respectively serving as a stable rotational fulcrum for the at least two clamping plates 2. The two first mounting shafts 11 are threadedly fastened with the mounting frame 1.

In some embodiments, the mounting frame 1 includes a housing 14 and a cover plate 15. Two ends of the first mounting shaft 11 are mounted on two opposite sidewalls of the housing 14, respectively. The housing 14 is provided with an opening. The cover plate 15 is detachably mounted over the opening. The housing 14 and the cover plate 15 cooperatively form a box-shaped enclosure. A length of the cover plate 15 is smaller than a length of the opening of the housing 14. After the cover plate 15 covers the opening, the notches 13 are formed at two ends of the opening, respectively. The notches 13 provide movement space for the at least two clamping plates 2.

Each of the at least two clamping plates 2 has a first end 21 and a second end 22, and is pivotally mounted on the first mounting shaft 11 with a hinge point located between the first end 21 and the second end 22, where the hinge point is close to the first end 21. Each of the at least two clamping plates 2 forms a pivotal connection with the mounting frame 1 via the first mounting shaft 11, so as to allow the at least two clamping plates 2 to swing around an axis of the first mounting shaft 11, thereby achieving the clamping and releasing actions of an object. The at least two clamping plates 2 are configured to be arc-shaped, and the cover plate 15 is also configured to be arc-shaped. In a clamping state, the at least two clamping plates 2 and the mounting frame 1 together form an arcuate semi-enclosed structure. Clamping surfaces of the at least two clamping plates 2 are conformally designed in accordance with an external profile of the object. For example, such clamping surfaces are incorporated with rubber padding layers, curved recesses, or non-slip textures, so as to enhance the friction coefficient and prevent damage to a surface of the object.

In some embodiments, the vertical column 3 is fixed to the mounting frame 1 by welding. Alternatively, the vertical column 3 is detachably fixed to the mounting frame 1 via bolts and nuts. The vertical column 3 is vertically arranged on the mounting frame 1. The first mounting shaft 11 is parallel to the vertical column 3, and is located between the at least two clamping plates 2.

In some embodiments, the linkage structure 4 serves as a core drive mechanism to achieve the clamping and releasing actions of the object. An external driving force is converted into the synchronous swing of the at least two clamping plates 2 through a transmission structure, so that the at least two clamping plates 2 are driven to swing synchronously towards each other to achieve clamping or to swing synchronously away from each other to achieve releasing.

The clamping mechanism for the lifting device in this application adopts a symmetrical double-hinged structure integrated with a linkage actuation system, achieving efficient and stable clamping of barrel-shaped objects. It features a simple structure and convenient operation, requires minimal installation space, and is easy to integrate into compact lifting devices.

In an embodiment, the mounting frame 1 is provided with a connecting plate 12. The clamping mechanism for the lifting device can be mounted on a lifting device via the connecting plate 12.

In an embodiment, the linkage structure 4 includes a first connection rod 41, two support rods 42, a second connection rod 43, a third connection rod 44 and a second mounting shaft 45. The first connection rod 41 is vertically arranged inside the vertical column 3. First ends of the two support rods 42 are hinged to the at least two clamping plates 2, respectively, and second ends of the two support rods 42 are hinged to a first end of the first connection rod 41. A first end of the second connection rod 43 is hinged to a second end of the first connection rod 41. A second end of the second connection rod 43 is hinged to an end of the third connection rod 44. The third connection rod 44 is hinged to the vertical column 3 via the second mounting shaft 45.

In some embodiments, the two support rods 42 are each configured to be adjustable in terms of length. The two support rods 42 each have two bearings and a lead screw, where the lead screw is provided with opposite-direction threads at two ends thereof. The two ends of the lead screw are each provided with a nut. A length of each of the two support rods 42 is adjusted by rotating the lead screw. By means of this, the clamping mechanism for the lifting device can clamp oil barrels with different diameters.

In some embodiments, the first ends of the two support rods 42 are respectively hinged to the first connection rod 41 via a first hinge shaft 421. The second ends of the two support rods 42 are respectively hinged to the first end 21 via a second hinge shaft 422. Such a hinge method adopts spherical connection.

The second end of the first connection rod 41 is hinged to the first end of the second connection rod 43 via a third hinge shaft 432. The second end of the second connection rod 43 is hinged to a first end of the third connection rod 44 via a fourth hinge shaft 433. The first end of the first connection rod 41 is configured to extend to the mounting frame 1. The two support rods 42 are each configured to be spherically connected to the first connection rod 41 and one of the at least two clamping plates 2.

The number of the second connection rod 43 is two. The two second connection rods 43 are arranged side by side. Each of the two second connection rods 43 is configured to extend between and interconnect the first connection rod 41 and the third connection rod 44.

The third connection rod 44 is divided by the second mounting shaft 45 into a first segment and a second segment, where the first segment extends from the second mounting shaft 45 to the fourth hinge shaft 433, and the second segment extends from the second mounting shaft 45 to a second end of the third connection rod 44. A length of the first segment is smaller than that of the second segment, thereby forming a lever to drive the at least two clamping plates 2 to clamp the oil barrel with a relatively small force.

The first connection rod 41 serves as a driving component and moves vertically along the axis of the vertical column 3. When the first connection rod 41 moves downward, it pulls the at least two clamping plates 2 via the two support rods 42, causing the at least two clamping plates 2 to swing outward about the first mounting shaft 11 to release the oil barrel. When the first connection rod 41 moves upward, it pushes the at least two clamping plates 2 inward via the two support rods 42, achieving the clamping action. Notably, the first connection rod 41 moves along a vertical direction while the at least two clamping plates 2 rotate in a horizontal plane. To accommodate this orthogonal motion, the first ends of the two support rods 42 are spherically connected to the at least two clamping plates 2, and the second ends of the two support rods 42 are spherically connected to the first connection rod 41. Such a spherical connection allows the two support rods 42 to self-adjust their orientation within a certain angular range, resulting in effectively compensating for positional and kinematic deviations during the swinging motion, and ensuring smooth, reliable force transmission and preventing mechanical interference.

The second connection rod 43 and the third connection rod 44 form a toggle linkage structure. When the external driving force is applied to the second end of the third connection rod 44, the third connection rod 44 swings about the second mounting shaft 45, thereby converting the swinging motion into a linear vertical motion of the first connection rod 41 via the second connection rod 43. The second mounting shaft 45 is mounted on an inner wall of the vertical column 3 at a position close to a hinge point between the second connection rod 43 and the third connection rod 44.

When a force is applied to the second end of the third connection rod 44, the first end of the third connection rod 44 drives the fourth hinge shaft 433 to rotate about the second mounting shaft 45. When the fourth hinge shaft 433 rotates above the second mounting shaft 45, the second mounting shaft 45 is located between the third hinge shaft 432 and the fourth hinge shaft 433. When the third hinge shaft 432, the second mounting shaft 45 and the fourth hinge shaft 433 reach a collinear position or move past the collinear position, an angle between the third connection rod 44 and the vertical direction is 0 degree or a negative angle. In this case, the second mounting shaft 45 reaches a toggle point, indicating that the first connection rod 41 is locked, and the at least two clamping plates 2 are firmly locked in a clamping position to prevent releasing.

During operation, the external driving force is applied to the second end of the third connection rod 44 through manual operation, pneumatic driving devices, hydraulic driving devices, electric driving devices or other driving devices. When it is necessary to clamp the object, the external driving force is applied to the third connection rod 44 to allow it swing downward around the second mounting shaft 45, such that the third connection rod 44 drives the second connection rod 43 to move upward through the hinge point. Furthermore, the second connection rod 43 drives the first connection rod 41 to move upward synchronously. During the upward movement of the first connection rod 41, an outward pushing force is respectively applied to the at least two clamping plates 2 through the two support rods 42 arranged at two sides of the first connection rod 41. Due to the spherical connection between the two support rods 42 and the at least two clamping plates 2, the first end and the second end of each of the two support rods 42 can effectively compensate for positional and kinematic deviations generated during the swinging motion of the at least two clamping plates 2, ensuring that the external driving force is always transmitted along an optimal direction. Under the external driving force, the at least two clamping plates 2 synchronously swing toward each other about their respective first mounting shafts 11, so that the clamping surfaces of the at least two clamping plates 2 gradually approach to clamp the object.

When it is necessary to release the object, the external driving force is reversely applied to the third connection rod 44, causing it to swing upward about the second mounting shaft 45. The third connection rod 44 drives the first connection rod 41 to move linearly downward through the second connection rod 43. The first connection rod 41 applies an inward pulling force to the at least two clamping plates 2 via the two support rods 42, pulling the at least two clamping plates 2 to swing reversely about their respective first mounting shafts 11. The clamping surfaces of the at least two clamping plates 2 gradually move away from the object until the object is completely released.

In an embodiment, the vertical column 3 is hollow, and has four sidewalls connecting successively. The first connection rod 41 and the second connection rod 43 are vertically arranged inside the vertical column 3. An end of the vertical column 3 away from the mounting frame 1 is provided with a mounting hole 31. The second end of the third connection rod is configured to extend out of the vertical column 3 through the mounting hole 31.

In an embodiment, a section shape of the vertical column 3 is square. The mounting hole 31 is long strip-shaped or arc-shaped. The mounting hole 31 is arranged on a first side 35 of the vertical column 3 to provide enough space for the swinging motion of the third connection rod 44.

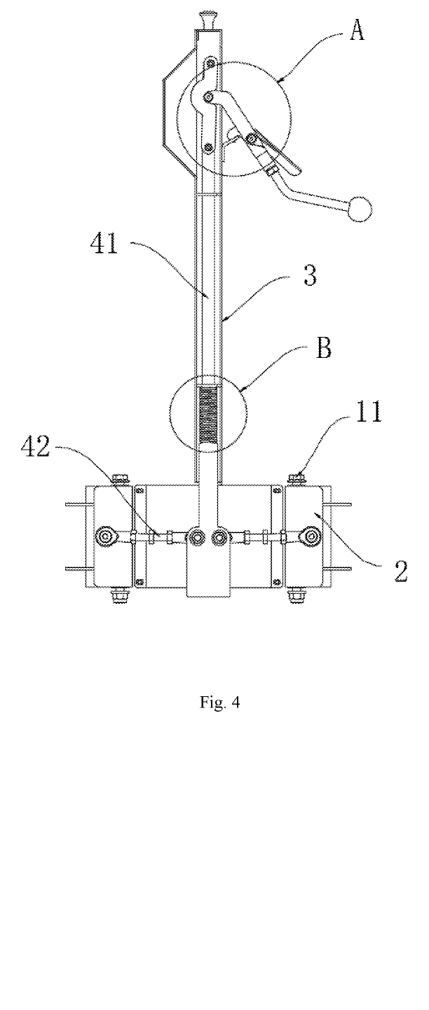

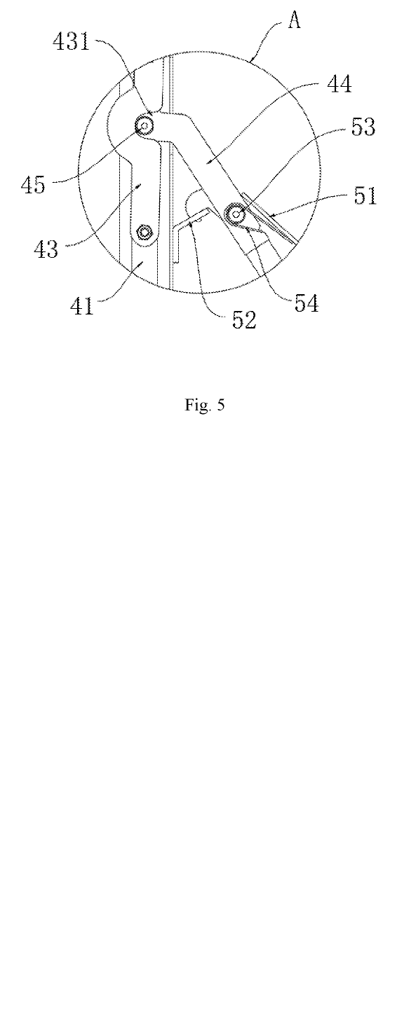

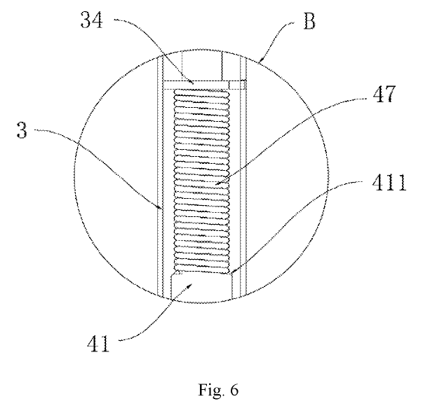

As shown in FIGS. 4-6, in an embodiment, the second connection rod 43 is provided with an engagement notch 431 configured for accommodating the second mounting shaft 45.

In an embodiment, the engagement notch 431 is semi-circular. An opening of the engagement notch 431 is provided with a guiding curved surface. The engagement notch 431 is configured to accommodate the second mounting shaft 45, such that the third hinge shaft 432, the second mounting shaft 45 and the fourth hinge shaft 433 reach the collinear position. When the at least two clamping plates 2 clamp the object and reach a predetermined clamping force, the third connection rod 44 swings downward about the second mounting shaft 45 to a limit position, at which the second mounting shaft 45 is securely engaged with the engagement notch 431, thereby achieving locking the second connection rod in place.

After the second mounting shaft 45 is engaged with the engagement notch 431, even if the external driving force undergoes fluctuations or temporary interruptions, the third connection rod 44 cannot swing upward about the second mounting shaft 45, thereby firmly locking the at least two clamping plates 2 in the clamping position and effectively preventing clamping loosening. Thus, this design enables the at least two clamping plates 2 to maintain the predetermined clamping force, requiring no continuous application of the external driving force under a clamping state.

To release the object, a sufficiently large reverse driving force is applied to cause the second mounting shaft 45 to overcome a retaining force of the engagement notch 431 and disengage therefrom. The third connection rod 44 then restores its freedom to swing upward about the second mounting shaft 45, thereby completing the release action.

In an embodiment, a position of the vertical column 3 corresponding to the second connection rod 43 is provided with an avoidance cavity 32.

In an embodiment, the avoidance cavity 32 is arranged on a sidewall of the vertical column 3 opposite to the first side 35. The avoidance cavity 32 is configured to extend along a height direction of the vertical column 3 to form a long strip-shaped slot. A width of the long strip-shaped slot is greater than a maximum swing amplitude of the second connection rod 43. A depth of the long strip-shaped slot is set such that when the second connection rod 43 moves with the at least two clamping plates 2 to the limit position, an overall contour of the second connection rod 43 is completely accommodated within the avoidance cavity 32 without interfering with a main body of the vertical column 3.

In an embodiment, the second end of the third connection rod 44 is detachably connected to an actuation lever 46.

In an embodiment, the actuation lever 46 is threadedly connected to or pinned to the second end of the third connection rod 44, facilitating the replacement of the actuation lever 46 of different specifications according to operational requirements.

In an embodiment, a retaining plate 34 is movably sleeved outside the first connection rod 41. The retaining plate 34 is fixedly connected to the inner wall of the vertical column 3. A first elastic component 47 is provided between the first connection rod 41 and the retaining plate 34, and is configured to drive the first connection rod 41 to reset.

In an embodiment, a plurality of retaining plates 34 is arranged space apart. The first elastic component 47 is a spring, but is not limited thereto.

In an embodiment, the two sides of the first connection rod 41 are each provided with a boss 411. The boss 411 is located under a retaining plate 34 among the plurality of retaining plates 34. The first elastic component 47 is sleeved over the first connection rod 41. Two ends of the first elastic component 47 are configured to abut against a lower end surface of the retaining plate 34 and the boss 411 of the first connection rod 41.

In some embodiments, the first connection rod 41 is maintained in a locking state under the action of a tension force of the first elastic component 47.

In some embodiments, the external driving force is applied to the first connection rod 41 to allow the first connection rod 41 to move upward, so that the first elastic component 47 is compressed to produce an elastic potential energy. When the external driving force is removed (i.e., after the engagement notch 431 is disengaged from the second mounting shaft 45), the first elastic component 47 releases the elastic potential energy to push the first connection rod 41 downward, so as to allow the at least two clamping plates 2 to automatically open, reaching an initial position.

In an embodiment, the third connection rod 44 is provided with a safety mechanism 5. The safety mechanism 5 is configured to lock the third connection rod 44 to maintain the at least two clamping plates 2 in the clamping state. The safety mechanism 5 can prevent the third connection rod 44 from swinging upward due to accidental contact with the actuation lever 46 or external force interference, which could cause the engagement notch 431 to disengage from the second mounting shaft 45 and lead to the accidental loosening of the at least two clamping plates 2.

In an embodiment, the safety mechanism 5 includes a trigger 51, a limit part 52 and a third mounting shaft 53. The trigger 51 is rotatably arranged on the third connection rod 44 via the third mounting shaft 53. The limit part 52 is arranged at an outer wall of a side of the vertical column 3 close to the trigger 51.

In an embodiment, a first end of the trigger 51 close to the limit part 52 is hook-shaped. An end of the limit part 52 close to the trigger 51 is frame-shaped. After the third connection rod 44 drives the at least two clamping plates 2 to clamp the object and is pressed downward to the limit position, the first end of the trigger 51 is engaged with the limit part 52, forming a mechanical locking structure that prevents the third connection rod 44 from swinging upward. When it is necessary to achieve the release action, a second end of the trigger 51 is pressed to disengage the first end of the trigger 51 from the limit part 52, allowing the third connection rod 44 to swing upward under the action of an external force, thereby causing the engagement notch 431 to disengage from the second mounting shaft 45 and the at least two clamping plates 2 to open accordingly. The safety mechanism 5 has a simple structure and enables quick operation, providing reliable anti-loosening protection during clamping.

In an embodiment, the safety mechanism 5 further includes a torsion spring 54. The torsion spring 54 is sleeved over the third mounting shaft 53. A first end of the torsion spring 54 is configured to abut against the trigger 51. A second end of the torsion spring 54 is configured to abut against the third connection rod 44. In this case, the torsion spring 54 provides a continuous reset force to the trigger 51, ensuring that the trigger 51 maintains a tendency to bias toward the limit part 52 in the absence of an external pressing force. It causes the first end of the trigger 51 to form a stable engagement with the frame-shaped end of the limit part 52, preventing the trigger 51 from accidentally disengaging due to vibration or inadvertent contact. When an operator presses the trigger 51 to release, the torsion spring 54 undergoes elastic deformation and stores potential energy. Upon release, the torsion spring 54 immediately releases the elastic potential energy to drive the trigger 51 to reset, preparing for the next locking operation.

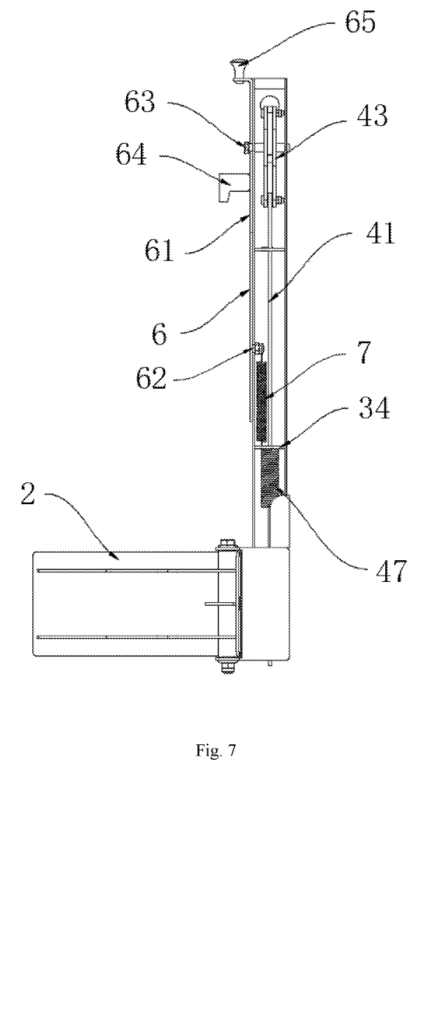

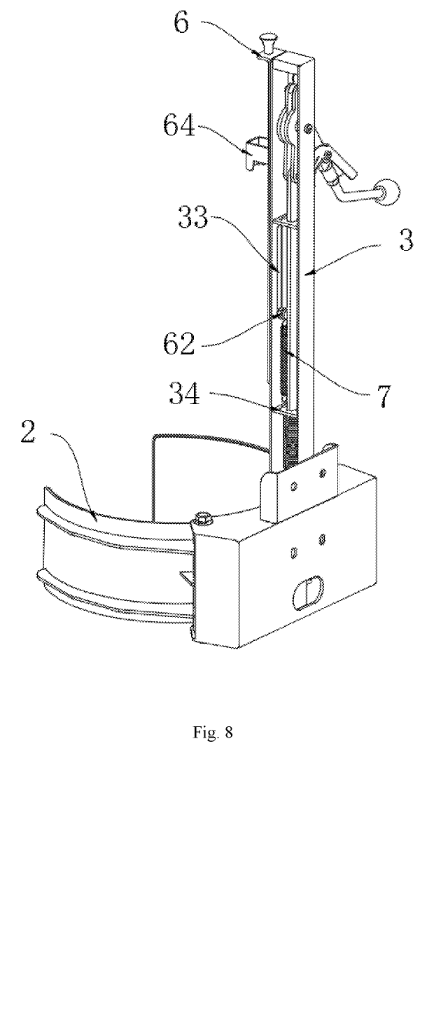

As shown in FIGS. 7-8, in an embodiment, the clamping mechanism for the lifting device further includes a sliding plate 6 arranged on the outer wall of the vertical column 3. A side of the sliding plate 6 close to the at least two clamping plates 2 is provided with a hook 64. The hook 64 is configured to limit an upper end of an object clamped by the at least two clamping plates 2.

In an embodiment, the sliding plate 6 is arranged on a sidewall of the vertical column 3, where the sidewall is adjacent to the first side 35 and close to the at least two clamping plates 2. The sliding plate 6 is configured to slide along the outer wall of the vertical column 3 to adjust a height of the sliding plate 6, so as to adapt to objects of different heights and sizes. The hook 64 is fixedly connected to the sliding plate 6. A front end of the hook 64 bends downward to form a hook-shaped structure.

After the at least two clamping plates 2 clamp a lower end of the object, the sliding plate 6 moves downward to an upper end of the object, so as to allow the hook 64 to hook a top edge of the object, thereby providing dual-directional positioning constraints (upper and lower) on the object and preventing the object from overturning or sliding during the processing.

In an embodiment, a side of the vertical column 3 close to the sliding plate 6 is provided with a first guide hole 33. The first guide hole 33 is internally provided with a first limit pin 62. A first end of the first limit pin 62 is fixedly connected to the sliding plate 6. A second end of the first limit pin 62 is configured to extend into the vertical column 3. An end of the sliding plate 6 away from the first guide hole 33 is provided with a second guide hole 61. The second guide hole 61 is internally provided with a second limit pin 63.

In an embodiment, the second mounting shaft 45 is configured to extend outward to form the second limit pin 63, or the second limit pin 63 is set up separately. The first guide hole 33 and the second guide hole 61 form a dual-point guiding structure, ensuring that the sliding plate 6 remains stable during vertical movement and preventing tilting or jamming caused by unilateral loading. The first limit pin 62 and the second limit pin 63 are each T-shaped, which prevents the sliding plate 6 from disengaging from the vertical column 3.

In an embodiment, a second elastic component 7 is arranged between the first limit pin 62 and a retaining plate 34 among the plurality of retaining plates 34. The second elastic component 7 is configured to maintain the hook 64 at a position for limiting the object clamped by at least two clamping plates 2.

In an embodiment, the second elastic component 7 is a spring, but is not limited thereto. The first limit pin 62 is located above a retaining plate 34 among the plurality of retaining plates 34. A first end of the second elastic component 7 is hooked to the first limit pin 62. A second end of the second elastic component 7 is connected to the retaining plate 34. The second elastic component 7 continuously pulls the sliding plate 6 downward through an elastic tensile force, maintaining the hook 64 in close contact with the top edge of the clamped object. Even if the clamped object undergoes slight vibration or displacement during processing, the hook 64 can automatically compensate for the gap and maintain a compressed state.

In an embodiment, an end of the sliding plate 6 away from the mounting frame 1 is provided with a pull handle 65.

In an embodiment, the pull handle 65 facilitates the operator to grip and apply force, enabling rapid vertical adjustment of the sliding plate 6. The position of the hook 64 can be adjusted, requiring no additional tools, significantly improving clamping efficiency and operational convenience. When it is necessary to adjust the height of the sliding plate 6 or to remove the object, the operator simply lifts the pull handle 65 upward. This causes the sliding plate 6 to slide upward, driving the hook 64 to disengage from the upper edge of the clamped object, thereby releasing the hook 64 from the object.

The embodiments described above are merely preferable embodiments of the present disclosure, and are not intended to limit this disclosure. Equivalent structure replacements obtained based on the description and the accompanying figures within the spirit and principle of the present disclosure, can be directly or indirectly applied to other related arts, and shall fall within the scope of the disclosure defined by the appended claims.

What is claimed is:

1. A clamping mechanism for a lifting device, comprising:
a mounting frame;
at least two clamping plates;
a vertical column;
a linkage structure;
wherein the at least two clamping plates are hinged to two sides of the mounting frame, respectively;
the vertical column is arranged on the mounting frame; and
the linkage structure is arranged on the vertical column, and is configured to control the at least two clamping plates to be in a clamping state or a releasing state.

2. The clamping mechanism of claim 1, wherein the linkage structure comprises a first connection rod, two support rods, a second connection rod, a third connection rod and a first mounting shaft; the first connection rod is vertically arranged inside the vertical column; and
first ends of the two support rods are hinged to the at least two clamping plates, respectively, and second ends of the two support rods are hinged to a first end of the first connection rod; a first end of the second connection rod is hinged to a second end of the first connection rod; a second end of the second connection rod is hinged to an end of the third connection rod; and the third connection rod is hinged to the vertical column via the first mounting shaft.

3. The clamping mechanism of claim 2, wherein the linkage structure further comprises a first hinge shaft and a second hinge shaft; the second end of the first connection rod is hinged to the first end of the second connection rod via the first hinge shaft; and the second end of the second connection rod is hinged to the end of the third connection rod via the second hinge shaft.

4. The clamping mechanism of claim 3, wherein in response to a case that the first hinge shaft, the first mounting shaft and the second hinge shaft reach a collinear position or move past the collinear position, the first connection rod is configured to be locked.

5. The clamping mechanism of claim 2, wherein a retaining plate is movably sleeved outside the first connection rod; the retaining plate is fixedly connected to an inner wall of the vertical column; a first elastic component is provided between the first connection rod and the retaining plate; and the first elastic component is configured to drive the first connection rod to reset.

6. The clamping mechanism of claim 2, wherein the third connection rod is provided with a safety mechanism; the safety mechanism comprises a trigger, a limit part and a second mounting shaft; the trigger is rotatably arranged on the third connection rod via the second mounting shaft; and the limit part is arranged at an outer wall of a side of the vertical column close to the trigger.

7. The clamping mechanism of claim 6, wherein the safety mechanism further comprises a torsion spring; the torsion spring is sleeved over the second mounting shaft; a first end of the torsion spring is configured to abut against the trigger; and a second end of the torsion spring is configured to abut against the third connection rod.

8. The clamping mechanism of claim 5, further comprising:
a sliding plate slidably arranged on an outer wall of the vertical column;
wherein a side of the sliding plate close to the at least two clamping plates is provided with a hook; and the hook is configured to limit an upper end of an object clamped by the at least two clamping plates.

9. The clamping mechanism of claim 8, wherein a side of the vertical column close to the sliding plate is provided with a first guide hole; the first guide hole is internally provided with a first limit pin; a first end of the first limit pin is fixedly connected to the sliding plate; a second end of the first limit pin is configured to extend into the vertical column; an end of the sliding plate away from the first guide hole is provided with a second guide hole; and the second guide hole is internally provided with the second limit pin.

10. The clamping mechanism of claim 9, wherein a second elastic component is provided between the first limit pin and the retaining plate, and is configured to maintain the hook at a position for limiting the object clamped by the at least two clamping plates.

11. A limiting mechanism for a lifting device, comprising:
a vertical column; and
a sliding plate;
wherein the sliding plate is slidably arranged on an outer wall of the vertical column; a side of the sliding plate away from the outer wall of the vertical column is provided with a hook; and the hook is configured to limit an upper end of a clamped object.

12. The limiting mechanism of claim 11, wherein a side of the vertical column close to the sliding plate is provided with a first guide hole; the sliding plate is provided with a first limit pin extending into the first guide hole; an end of the sliding plate away from the first guide hole is provided with a second guide hole; and the vertical column is internally provided with a second limit pin extending into the second guide hole.

13. The limiting mechanism of claim 12, further comprising:
an elastic component;
wherein a first end of the elastic component is connected to the first limit pin; a second end of the elastic component is connected to the vertical column; and the elastic component is configured to maintain the hook at a position for limiting the clamped object.
